(19) United States
(12) Patent Application Publication
(10) Pub. No.: US 2026/0237949 A1
(43) Pub. Date: Aug. 13, 2026

(54) RELAY CONNECTOR

(71) Applicant: SUMITOMO WIRING SYSTEMS, LTD., Mie (JP)

(72) Inventor: Yuto OKANO, Mie (JP)

(21) Appl. No.: 19/155,945

(22) PCT Filed: Feb. 13, 2024
(86) PCT No.: PCT/JP2024/004811

§ 371 Date: Aug. 13, 2025

(30) Foreign Application Priority Data
Feb. 15, 2023 (JP) 2023-021527

(51) Int. Cl. H01R 31/06; H01R 13/04; H01R 13/52; H01R 13/645

(52) U.S. Cl. CPC H01R 31/06; H01R 13/04; H01R 13/521; H01R 13/6456

(57) ABSTRACT

A relay connector includes a plurality of conductive terminals and a housing including a body portion holding the plurality of terminals, and a tubular first connector fitting portion protruding from a first end surface of the body portion in a first direction. The relay connector includes a recessed portion recessed from the first end surface of the body portion in the first opposite direction and surrounding the plurality of terminals, and a potting material filling the recessed portion and sealing the plurality of terminals. The housing includes one or more protruding portions protruding from the first end surface in the first direction, and protruding radially inward of the first connector fitting portion from an inner circumferential surface of the first connector fitting portion.

### TECHNICAL FIELD

The present disclosure relates to a relay connector.

### BACKGROUND

Conventionally, relay connectors attached to a device case that contains oil, such as a transmission case, for example, are known as connectors for vehicles (see, for example, Patent Document 1). A relay connector is a connector for electrically connecting the inside and outside of a device case. In this type of relay connector, the oil sealing function is enhanced by a potting material to prevent oil or the like inside the device case from leaking to the outside of the device case. Specifically, a recessed portion is provided in a housing that holds a plurality of terminals, and the recessed portion is filled with the potting material. The potting material is then bonded to the plurality of terminals to prevent oil in the device case from leaking to the outside of the device case through the terminals.

### PRIOR ART DOCUMENT

### Patent Document

Patent Document 1: JP 2000-040551 A

### SUMMARY OF THE INVENTION

### Problems to be Solved

In recent years, the device case to which the relay connector is attached has been downsized and space-saving has been promoted, and the relay connector has been downsized accordingly. As relay connectors is downsized, the recessed portion filled with the potting material is also downsized, thus reducing a distance between an outer edge of the recessed portion and the terminals. This causes stress concentration in the potting material due to the difference in linear expansion coefficients between the potting material and the housing, making it easy to generate cracks in the potting material.

An object of the present disclosure is to provide a relay connector that can suppress cracking of potting material.

### Means to Solve the Problem

A relay connector according to the present disclosure is a relay connector including: a plurality of conductive terminals; a housing including a body portion holding the plurality of terminals, a tubular first connector fitting portion protruding in a first direction from a first end surface of the body portion; and a tubular second connector fitting portion protruding in a first opposite direction opposite to the first direction from a second end surface provided opposite to the first end surface of the body portion; a recessed portion recessed from the first end surface of the body portion in the first opposite direction and surrounding the plurality of terminals; and a potting material filling the recessed portion and sealing the plurality of terminals, wherein the housing includes one or more protruding portions protruding from the first end surface in the first direction, and protruding radially inward of the first connector fitting portion from an inner circumferential surface of the first connector fitting portion, and leading ends of the one or more protruding portions in a radial inner direction push into the recessed portion in plan view as viewed from the first direction.

### Effect of the Invention

With the relay connector of the present disclosure, the effect of suppressing cracking of potting material can be exhibited.

### BRIEF DESCRIPTION OF THE DRAWINGS

FIG. 1 is a schematic cross-sectional view (cross-sectional view taken along line 1-1 in FIG. 3) of an embodiment of a relay connector.

FIG. 2 is a schematic perspective view showing the relay connector according to the embodiment.

FIG. 3 is a schematic plan view showing the relay connector according to the embodiment.

FIG. 4 is a schematic cross-sectional view (cross-sectional view taken along line 4-4 in FIG. 1) showing the relay connector according to the embodiment.

### DETAILED DESCRIPTION TO EXECUTE THE INVENTION

### Description of Embodiments of Present Disclosure

First, embodiments of the present disclosure will be listed and described.

[1] A relay connector according to a present disclosure including: a plurality of conductive terminals; a housing including a body portion holding the plurality of terminals a tubular first connector fitting portion protruding in a first direction from a first end surface of the body portion; and a tubular second connector fitting portion protruding in a first opposite direction opposite to the first direction from a second end surface provided opposite to the first end surface of the body portion; a recessed portion recessed from the first end surface of the body portion in the first opposite direction and surrounding the plurality of terminals; and a potting material filling the recessed portion and sealing the plurality of terminals, wherein the housing includes one or more protruding portions protruding from the first end surface in the first direction, and protruding radially inward of the first connector fitting portion from an inner circumferential surface of the first connector fitting portion, and leading ends of the one or more protruding portions in a radial inner direction push into the recessed portion in plan view as viewed from the first direction.

According to this configuration, the leading ends of the protruding portions protruding radially inward from the inner circumferential surface of the first connector fitting portion push into the recessed portion in plan view as viewed from the first direction. In other words, the recessed portion filled with the potting material extends radially outward relative to the leading ends of the protruding portions. Thus, even when the leading ends of the protruding portions extend to the vicinity of the terminals, for example, due to the downsizing of the opening of the first connector fitting portion, the outer edge of the recessed portion can be suitably spaced apart from the terminals to ensure a long distance between the outer edge of the recessed portion and the terminals. This prevents reduction of the distance between the outer edge of the recessed portion and the terminals compared to a case where the recessed portion is formed only in the region radially inward of the leading ends of the protruding portions. As a result, stress concentration in the potting material filled in the recessed portion can be suppressed, and cracking in the potting material can be suitably suppressed.

[2] In [1] above, the one or more protruding portions may include a misassembly-prevention protruding portion, and the recessed portion surrounds the leading end of the misassembly-prevention protruding portion in the radial inner direction from three directions in plan view as viewed from the first direction.

According to this configuration, the recessed portion may surround the side wall of the misassembly-prevention recessed portion. Therefore, the recessed portion can suitably extend radially outward relative to the leading end of the misassembly-prevention protruding portion. In this manner, even when the leading end of the misassmbly-prevention protruding portion extends to the vicinity of the terminals, reduction of the distance between the outer edge of the recessed portion and the terminals can be suitably suppressed. As a result, cracking of the potting material can be suitably suppressed.

[3] In [1] or [2] above, the leading ends of the one or more protruding portions in the radial inner direction may be tapered, and the outer edge of the recessed portion may have a shape conforming to the leading ends of the one or more protruding portions in the radial inner direction in plan view as viewed from the first direction.

According to this configuration, the leading ends of the protruding portions are tapered. The leading ends of the protruding portions are thus spaced further apart from the terminals progressively toward the side wall of the protruding portion. Since the recessed portion has a shape conforming to the leading ends of the protruding portions, the outer edge of the recessed portion can be suitably spaced apart from the terminals. In this manner, even when the leading ends of the protruding portions extend to the vicinity of the terminals, reduction in the distance between the outer edge of the recessed portion and the terminals can be suitably suppressed.

[4] In [1] above, a configuration is also possible in which the housing has an enlarged recessed portion recessed from an inner circumferential surface of the first connector fitting portion outward in a radial direction of the first connector fitting portion and enlarging an internal space of the first connector fitting portion, and the recessed portion extends into the enlarged recessed portion in plan view as viewed from the first direction.

According to this configuration, the enlarged recessed portion is provided in the inner circumferential surface of the first connector fitting portion. This allows the internal space of the first connector fitting portion to be enlarged while suppressing an increase in size of the first connector fitting portion. Furthermore, since the recessed portion extends into of the enlarged recessed portion, the outer edge of the recessed portion can be suitably spaced apart from the terminals, thus ensuring a long distance between the outer edge of the recessed portion and the terminals.

[5] In any one of [1] to [4] above, a configuration is also possible in which the outer edge of the recessed portion has, in plan view as viewed from the first direction, a curved shape curved away from the terminals disposed outward in the radial direction of the first connector fitting portion, out of the plurality of terminals.

According to this configuration, the outer edge of the recessed portion has a curved shape. This improves the fluidity of the potting material when filling the recesses with the potting material. In this manner, it is possible to suppress the potting material from remaining at the outer edge of the recessed portion, and making it possible to suitably suppress the potting material from creeping up at the recessed portion at the outer edge of the recessed portion.

[6] In any one of [1] to [5] above, a configuration is also possible in which the outer edge of the recess has only a curved shape.

According to this configuration, the outer edge of the recessed portion is formed only by a curved shape. This allows for better fluidity of the potting material when filling the recessed portion. In this manner, it is possible to suppress the potting material from creeping up at the outer edge of the recessed portion.

[7] In any one of [1] to [6] above, a configuration is also possible in which the relay connector is configured to be attached to an attachment hole of a device case whose external space is an air environment and whose internal space is an oil environment, the first end surface is an end surface facing the outside of the device case, and the second end surface is an end surface facing the inside of the device case, the first connector fitting portion is provided to protrude into the external space of the device case, and the second connector fitting portion is provided to protrude into the internal space of the device case.

According to this configuration, the recessed portion is provided in the first end surface facing the outside of the device case, and the recessed portion is filled with the potting material. This potting material can suitably suppress oil leakage from the inside of the device case, which is an oil environment, to the outside of the device case through the terminals.

[8] In any one of [1] to [7] above, a configuration is also possible in which the first connector fitting portion has a non-waterproof structure in which a counterpart connector, which is a non-waterproof connector, is configured to be fitted inside, and the first connector fitting portion is provided in a portion of the first connector fitting portion in a circumferential direction and has a through hole that communicates the inside and outside of the first connector fitting portion.

According to this configuration, the counterpart connector which is a non-waterproof connector is fitted into the first connector fitting portion. In this case, since the opening of the first connector fitting portion is small, the leading ends of the protruding portions tend to extend to the vicinity of the terminals. Even in such a case, reduction in distance between the outer edge of the recessed portion and the terminals can be suitably suppressed. As a result, cracks in the potting material can be suitably suppressed.

### Detailed Description of Embodiments of Disclosure

A specific example of a relay connector according to an embodiment of the present disclosure will be described below with reference to the drawings. In the drawings, the configurations may be partially exaggerated or simplified for convenience in the description. Also, the dimensional ratios of various portions may differ among the drawings. The terms “parallel” and “orthogonal” in this specification include not only strictly parallel and orthogonal relationships, but also approximately parallel and orthogonal relationships to the extent that effects of the present embodiment are achieved. A “tubular shape” as described herein includes not only a shape with a circumferential wall continuously formed around the entire circumference in a circumferential direction, but also a tubular shape formed by a combination of a plurality of components, and a tubular shape having a partially cut-out portion or the like in a circumferential direction thereof, such as a C-shape. The outer circumferential shape of the “tubular shape” includes, but is not limited to, a circular shape, an elliptic shape, and a polygonal shape having a pointed or round angle. It should be noted that the present invention is not intended to be limited to these examples, but rather is indicated by the claims, and is intended to include all modifications within the meaning and scope equivalent to the scope of claims.

### Overall Configuration

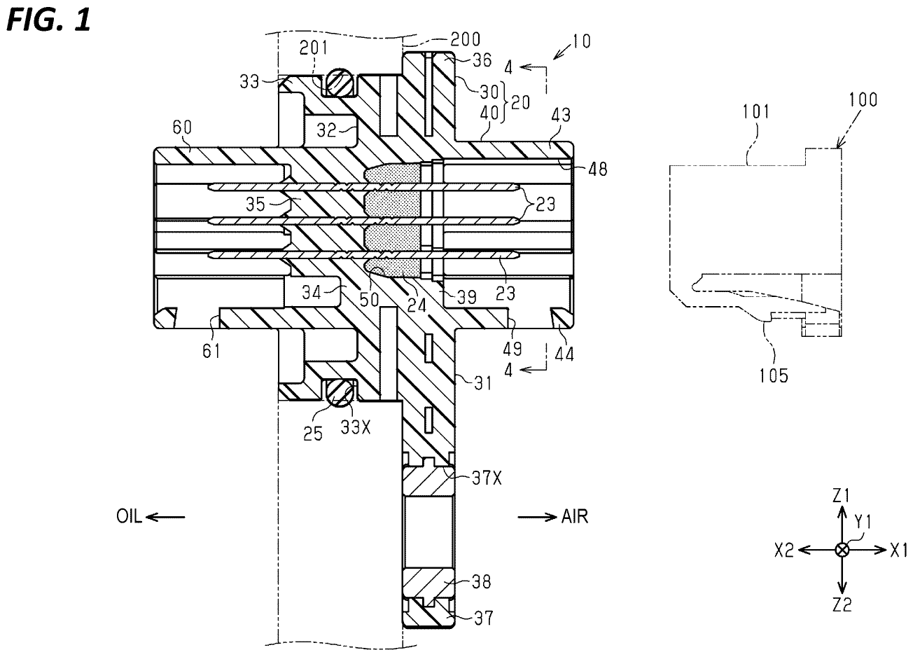

As shown in FIG. 1, a relay connector 10 is attached to a device case 200 mounted in a vehicle. The relay connector 10 is configured to be attached to the device case 200 in any orientation in accordance with the posture of the device case 200, for example. The relay connector 10 is fixed to the device case 200 by, for example, a bolt or the like. The relay connector 10 is a connector for electrically connecting the inside and the outside of the device case 200.

The device case 200 is, for example, a transmission case. The device case 200 is made of metal, for example. The inside of the device case 200 is an oil environment, and the outside of the device case 200 is an air environment. For example, electric components such as a motor and a sensor are provided inside the device case 200. The device case 200 has an attachment hole 201 through which the relay connector 10 passes. The attachment hole 201 communicates the inside and the outside of the device case 200.

The relay connector 10 is fitted into the attachment hole 201 of the device case 200. The relay connector 10 is electrically connected to a counterpart connector 100 provided in a control unit that is outside the device case 200 and houses a control circuit and the like. Although not illustrated, inside the device case 200, the relay connector 10 is electrically connected to a second counterpart connector provided inside the device case 200, for example. The control circuit provided in the control unit is, for example, electrically connected to the electrical components provided inside the device case 200 via the counterpart connector 100, the relay connector 10, and the second counterpart connector.

### Configuration of Relay Connector 10

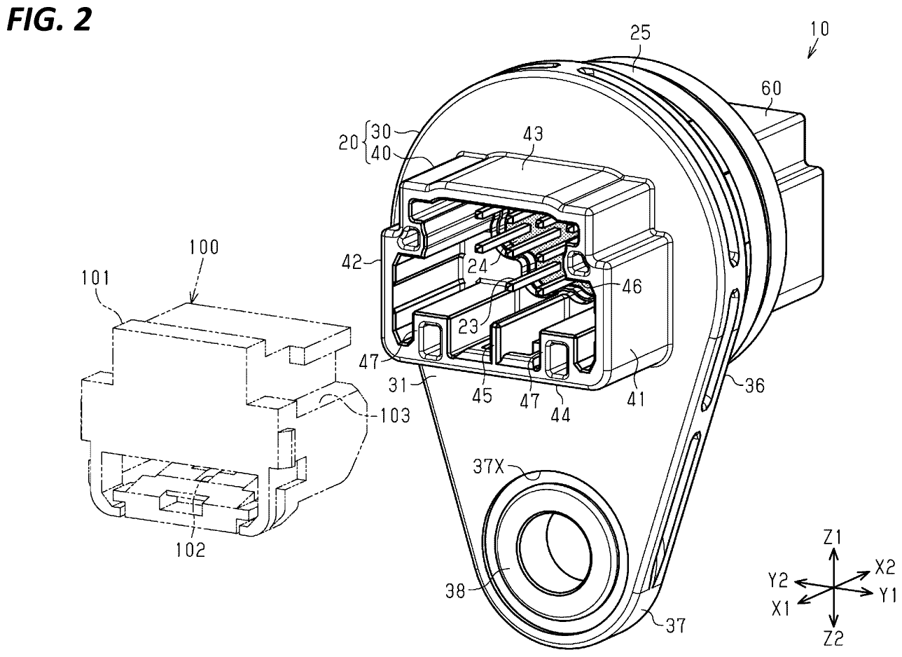

As shown in FIGS. 1 and 2, the relay connector 10 includes a housing 20, a plurality of terminals 23 held by the housing 20 and having electrical conductivity, a potting material 24 that seals the plurality of terminals 23, and a seal member 25. The relay connector 10 of the present embodiment includes ten terminals 23.

### Configuration of Housing 20

As shown in FIG. 1, the housing 20 includes a body portion 30 and a tubular first connector fitting portion 40 protruding from a first end surface 31 of the body portion 30 in a first direction X1. The housing 20 has a tubular second connector fitting portion 60 protruding from a second end surface 32 of the body portion 30 in a first opposite direction X2 that is a direction opposite to the first direction X1. Here, the first end surface 31 is an end surface facing the outside of the device case 200, and the second end surface 32 is an end surface facing the inside of the device case 200. The housing 20 is, for example, a single component in which the body portion 30, the first connector fitting portion 40, and the second connector fitting portion 60 are continuously and integrally formed. The housing 20 is made of, for example, an insulating synthetic resin. As the material of the housing 20, for example, polyolefin, polyamide, polyester, or polybutylene terephthalate can be used.

In the following description, when describing the positional relationship of the constituent elements of the relay connector 10, a direction toward the right in FIG. 2 among directions orthogonal to the first direction X1 is referred to as a second direction Y1, and a direction opposite to the second direction Y1 is referred to as a second opposite direction Y2. Out of the directions orthogonal to both the first direction X1 and the second direction Y1, the direction toward the upper side in FIG. 2 is referred to as a third direction Z1, and the direction opposite to the third direction Z1 is referred to as a third opposite direction Z2. Directions in the counterpart connector 100 are described based on a state in which the counterpart connector 100 is assembled to the relay connector 10.

### Configuration of Body Portion 30

As shown in FIG. 1, the body portion 30 includes, for example, an insertion portion 33 that is inserted into the attachment hole 201 of the device case 200, a terminal holding portion 35 that holds the plurality of terminals 23, and a flange portion 36 that is provided in an external space of the device case 200.

The insertion portion 33 is inserted into the attachment hole 201 of the device case 200 along the first opposite direction X2, for example. The insertion portion 33 is fitted inside the attachment hole 201. The insertion portion 33 has, for example, a tubular shape. The insertion portion 33 is, for example, open in the first opposite direction X2. The outer circumferential surface of the insertion portion 33 has a shape conforming to an inner circumferential surface defining the attachment hole 201, for example. The insertion portion 33 has, for example, a tubular shape in which a circumferential wall is continuously formed over the entire circumference in the circumferential direction, that is, an endless structure in which a starting end and a terminal end coincide with each other.

The outer circumferential surface of the insertion portion 33 is provided with, for example, an accommodation groove 33X in which the seal member 25 is accommodated. The accommodation groove 33X is recessed inward in the radial direction of the insertion portion 33 from the outer circumferential surface of the insertion portion 33. The accommodation groove 33X is formed, for example, over the entire circumference in the circumferential direction of the outer circumferential surface of the insertion portion 33. The tubular seal member 25 is fitted to the accommodation groove 33X. When the insertion portion 33 is fitted into the attachment hole 201, the seal member 25 comes into close contact with the inner circumferential surface defining the attachment hole 201, over the entire circumference in the circumferential direction, and seals between the outer circumferential surface of the housing 20 and the inner circumferential surface of the device case 200.

### Configuration of Seal Member 25

The seal member 25 is configured to be elastically deformable. The seal member 25 has, for example, a tubular shape continuous over the entire circumference in the circumferential direction of the insertion portion 33, that is, in an endless structure in which a starting end and a terminal end coincide with each other. The seal member 25 is, for example, an O-ring. The inner circumference of the seal member 25 has a shape conforming to the outer circumference of the insertion portion 33, for example. The outer circumference of the seal member 25 has a shape conforming to the inner circumferential surface defining the attachment hole 201, for example. The seal member 25 of the present embodiment has a cylindrical shape whose inner circumference and the outer circumference have a circular shape. The seal member 25 is made of rubber, for example.

### Configuration of Body Portion 30

The body portion 30 includes, for example, a bottom wall 34 that closes an opening of the insertion portion 33 in the first direction X1. An end surface of the bottom wall 34 in the first opposite direction X2 constitutes the second end surface 32 of the body portion 30.

The terminal holding portion 35, for example, protrudes from the end surface of the bottom wall 34 in the first opposite direction X2, that is, from the second end surface 32 of the body portion 30 in the first opposite direction X2. The terminal holding portion 35 is provided, for example, in the internal space of the insertion portion 33. The terminal holding portion 35 is provided, for example, in the internal space of the second connector fitting portion 60. The terminal holding portion 35, for example, is formed continuously and integrally with the circumferential wall of the second connector fitting portion 60. The terminal holding portion 35 is provided, for example, in the radial direction of the insertion portion 33, away from the inner circumferential surface of the insertion portion 33.

The terminal holding portion 35, for example, covers the outer circumferential surface of each terminal 23 in a close contact state in the entire circumference in the circumferential direction. The terminal holding portion 35, for example, holds an intermediate portion of each terminal 23 in the axially intermediate portion in an embedded state. In other words, a portion of each terminal 23 is embedded inside the housing 20.

Here, the terminals 23 have a rod-shape, for example. The terminals 23 extend in a straight line along, for example, the first direction X1. The terminals 23 are made of metal, for example. The terminals 23, for example, protrude in the first direction X1 from the end surface of the terminal holding portion 35 in the first direction X1 and in the first opposite direction X2 from the end surface of the terminal holding portion 35 in the first opposite direction X2.

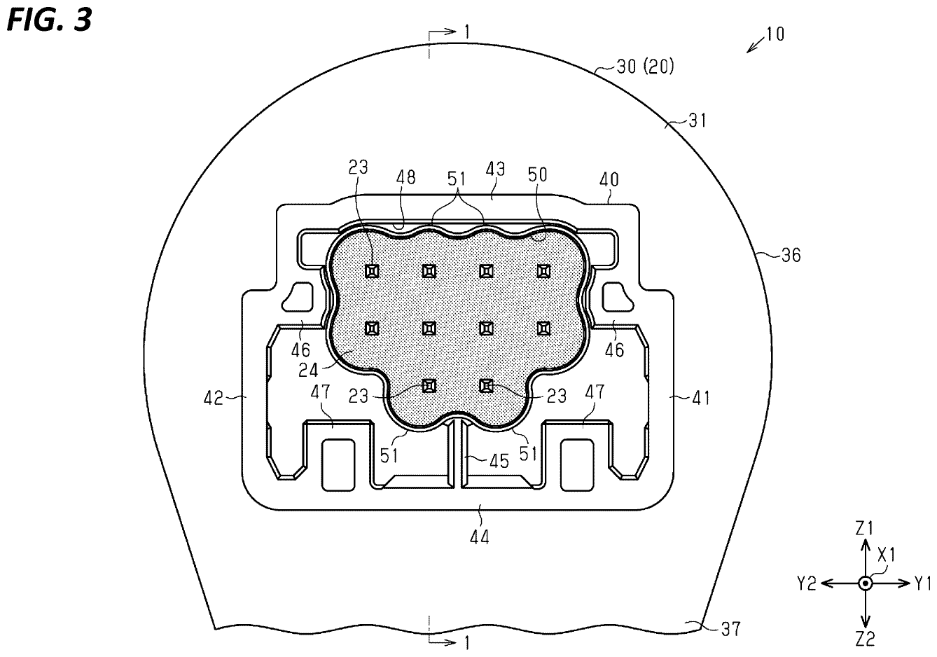

As shown in FIG. 3, the ten terminals 23 are, for example, provided at intervals along the second direction Y1 and at intervals along the third direction Z1, in plan view as viewed from the first direction X1. The ten terminals 23 are arranged in a grid or matrix shape, for example, in plan view as viewed from the first direction X1. Eight of the ten terminals 23 are arranged in a 4×2 matrix. The remaining two terminals 23 are located farther apart in the third opposite direction Z2 than the eight terminals 23. The remaining two terminals 23 are located in the center in the second direction Y1.

As shown in FIG. 1, the flange portion 36 is provided in the external space of the device case 200 when the insertion portion 33 is fitted into the attachment hole 201. The flange portion 36, for example, extends radially outward relative to the outer circumferential surface of the insertion portion 33. The flange portion 36, for example, projects radially outward over the entire circumference of the insertion portion 33. In other words, the flange portion 36 protrudes in a direction orthogonal to a direction in which the insertion portion 33 is inserted into the attachment hole 201 (here, the first opposite direction X2). The end surface of flange portion 36 in the first opposite direction X2 can come into contact with the outer surface of the device case 200. The end surface of the flange portion 36 in the first opposite direction X2 is configured to be engaged with the outer surface of the device case 200 in the first direction X1, for example. The insertion portion 33, for example, protrudes in the first opposite direction X2 from the end surface of the flange portion 36 in the first opposite direction X2. An end surface of the flange portion 36 in the first direction X1 constitutes the first end surface 31 of the body portion 30.

As shown in FIG. 2, the flange portion 36 has a fixed portion 37, for example. The protruding amount of the fixed portion 37 radially outward is greater than the other portions. The fixed portion 37 of the present embodiment protrudes in the third opposite direction Z2. The fixed portion 37 has a plate shape. The fixed portion 37 has, for example, a through hole 37X extending through the fixed portion 37 in the thickness direction (here, the first direction X1). A metal collar 38, for example, is inserted into the through hole 37X. The collar 38, for example, has a cylindrical shape. A fixing bolt (not shown) is inserted into the hole in the collar 38. As shown in FIG. 1, the housing 20 is fixed to the device case 200 by a fastening bolt that is inserted into the hole in the collar 38.

As shown in FIG. 1, the body portion 30 has a bottom wall 39 that closes an opening of the first connector fitting portion 40 in the first opposite direction X2, for example. The bottom wall 39, for example, is formed continuously and integrally with the bottom wall 34. The end surface of the bottom wall 39 in the first direction X1 constitutes the first end surface 31 of the body portion 30. The end surface of the bottom wall 39 in the first direction X1 constitutes the bottom surface of the first connector fitting portion 40.

### Configuration of First Connector Fitting Portion 40

The first connector fitting portion 40 is provided in the external space of the device case 200 when the insertion portion 33 is fitted to the attachment hole 201. The counterpart connector 100 provided outside the device case 200 is fitted to the first connector fitting portion 40. Here, the counterpart connector 100 has a counterpart housing 101 and fitting terminals (not shown) held in the counterpart housing 101 and electrically connected to the terminals 23. The counterpart connector 100 is a non-waterproof connector. The counterpart housing 101 of the counterpart connector 100 is fitted inside the first connector fitting portion 40 along the first opposite direction X2. The first connector fitting portion 40 of the present embodiment has a non-waterproof structure where the counterpart connector 100, a non-sealed connector, is fitted inside.

The first connector fitting portion 40 protrudes in the first direction X1 from the first end surface 31, that is, the end surface of the flange portion 36 in the first direction X1. The first connector fitting portion 40 protrudes toward the external space of the device case 200. The first connector fitting portion 40, for example, is open in the first direction X1. The first connector fitting portion 40, for example, surrounds the outer circumferences of the terminals 23 protruding from the potting material 24 in the first direction X1. The inner circumferential surface of the first connector fitting portion 40 is spaced apart from the terminals 23. The inner circumferential surface of the first connector fitting portion 40, for example, surrounds the outer circumference of the terminals 23 in the entire circumferential direction while spaced apart from the terminals 23.

As shown in FIGS. 2 through 4, the first connector fitting portion 40 has, for example, a rectangular tubular shape as a whole. The first connector fitting portion 40 has, for example, the circumferential wall 41 in the second direction Y1, the circumferential wall 42 in the second opposite direction Y2, the circumferential wall 43 in the third direction Z1, and a circumferential wall 44 in the third opposite direction Z2. The circumferential walls 41 and 42 each have a stepped part at the end portion in the third direction Z1.

The inner circumferential surface of the first connector fitting portion 40 is provided with protruding portions 45 and 46, and 47 that protrude from the inner circumferential surface of the first connector fitting portion 40 radially inward of the first connector fitting portion 40. The first connector fitting portion 40 in the present embodiment has one protruding portion 45, two protruding portions 46, and two protruding portions 47. The first connector fitting portion 40 has, for example, a plane-symmetrical shape with respect to a virtual plane that includes the center of the first connector fitting portion 40 in the second direction Y1 and extends into the XZ plane.

As shown in FIG. 2, the protruding portions 45, 46, and 47 extends along the first direction X1. The protrusions 45, 46, and 47 extend the entire axial length of the first connector fitting portion 40, for example.

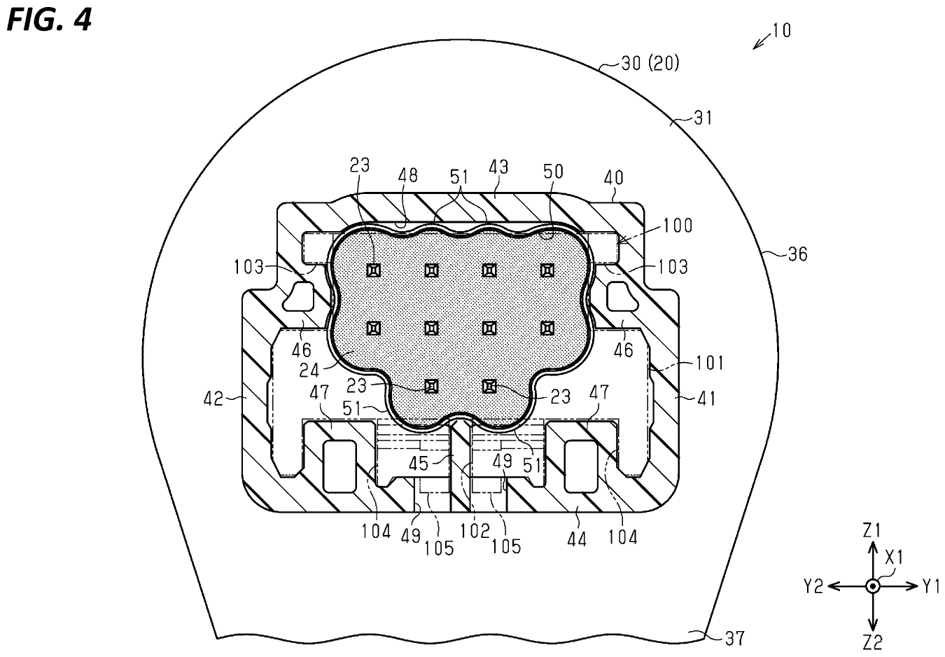

The one protruding portion 45 is provided, for example, on the inner circumferential surface of the circumferential wall 44. The protruding portion 45 protrudes from the inner circumferential surface of the circumferential wall 44 radially inward (here, in the third direction Z1) of the first connector fitting portion 40. The protruding portion 45 is provided, for example, in the central portion of the circumferential wall 44 in the second direction Y1. The leading end of the protruding portion 45 inward in the radial direction, i.e., the end portion of the protruding portion 45 in the third direction Z1, extends, for example, to the vicinity of the plurality of terminals 23. As shown in FIG. 4, the leading end of the protruding portion 45 in the radially inner direction is tapered, for example. The shape of the first connector fitting portion 40, including the protruding portion 45, is not rotationally symmetrical, for example. The protruding portion 45 is, for example, a misassembly-prevention protruding portion for preventing the counterpart connector 100 from being fitted with the first connector fitting portion 40 in an incorrect orientation. The protruding portion 45 is configured to be inserted into a misassembly-prevention groove 102 provided in the counterpart housing 101 along the first direction X1, for example. The protruding portion 45 is configured to, in a state where the counterpart housing 101 is fitted with the first connector fitting portion 40, engage with the misassembly-prevention groove 102 in the circumferential direction of the first connector fitting portion 40.

The two protruding portions 46 are provided, for example, one on the inner circumferential surface of the circumferential wall 41 and the other one on the inner circumferential surface of the circumferential wall 42. The one protruding portion 46 protrudes from the inner circumferential surface of the circumferential wall 41 radially inward of the first connector fitting portion 40 (here, the second opposite direction Y2). The other protruding portion 46 protrudes from the inner circumferential surface of the circumferential wall 42 radially inward of the first connector fitting portion 40 (here, in the second direction Y1). Two protruding portions 46 are provided on the inner circumferential wall at the stepped parts of the circumferential walls 41 and 42, respectively, for example. The two protruding portions 46 oppose each other in the second direction Y1, for example. The leading end in the radially inner direction of each protruding portion 46 extends, for example, to the vicinity of the plurality of terminals 23. The leading end of each protruding portion 46 in the radially inner direction is tapered, for example. Each protruding portion 46 is, for example, a guide projection that guides the counterpart connector 100 when fitting the counterpart connector 100 to the first connector fitting portion 40. Each protruding portion 46 is inserted into a corresponding guide groove 103 provided in the counterpart housing 101 along the first direction X1, for example. Each protruding portion 46 is provided so as to be engageable with the guide groove 103 in the circumferential direction of the first connector fitting portion 40 in a state where the counterpart housing 101 is fitted into the first connector fitting portion 40, for example.

The two protruding portions 47 are provided, for example, on the inner circumferential surface of the circumferential wall 44. The two protruding portions 47 protrude radially inward of the first connector fitting portion 40 (here, in the third direction Z1) from the inner circumferential surface of the circumferential wall 44. The two protruding portions 47 sandwich the protruding portion 45 from the opposite sides in the second direction Y1. The leading end in the radially inner direction of each protruding portion 47 is provided, for example, at a position spaced apart from the plurality of terminals 23 as compared with the other protruding portions 45 and 46. The protruding portions 47 are, for example, guide projections that guide the counterpart connector 100 when the counterpart connector 100 is fitted into the first connector fitting portion 40. The protruding portions 47 are inserted into a guide groove 104 provided in the counterpart housing 101 along the first direction X1, for example. The protruding portions 47 are engageable with the guide groove 104 in the circumferential direction of the first connector fitting portion 40, for example, in a state where the counterpart housing 101 is fitted into the first connector fitting portion 40.

The first connector fitting portion 40 has, for example, an enlarged recessed portion 48 that enlarges the internal space of the first connector fitting portion 40. The enlarged recessed portion 48 is, for example, recessed radially outward of the first connector fitting portion 40 from the inner circumferential surface of the circumferential wall 43. The enlarged recessed portion 48 extends in the second direction Y1, for example. The enlarged recessed portion 48 is provided, for example, in a region facing the terminals 23 in the third direction Z1.

The first connector fitting portion 40 has, for example, one or more through holes 49 that communicate the inside and the outside of the first connector fitting portion 40. The first connector fitting portion 40 of the present embodiment has two through holes 49. The two through holes 49 are provided in a portion of the first connector fitting portion 40 in the circumferential direction. The two through holes 49 are provided, for example, on opposite sides of the protruding portion 45 in the second direction Y1. The through holes 49 extend through the circumferential wall 44 in the third direction Z1, for example. As shown in FIG. 1, the through holes 49 are provided in an intermediate portion of the circumferential wall 44 in the first direction X1. An inner surface defining each through hole 49 is engageable with a corresponding engagement projection 105 of the counterpart housing 101. An inner surface defining each through hole 49 is engageable with the engagement projection 105 in the first direction X1.

The first connector fitting portion 40 has a recessed portion 50 on the bottom surface of the first connector fitting portion 40, i.e., an end surface of the bottom wall 39 in the first direction X1. The recessed portion 50 is recessed from the bottom surface of the first connector fitting portion 40 in the first opposite direction X2. The recessed portion 50 is, for example, recessed to an intermediate portion of the bottom wall 34, which forms a portion of the insertion portion 33. The recessed portion 50, for example, is formed such that its opening width decreases progressively from the bottom surface of the first connector fitting portion 40 in the first opposite direction X2.

As shown in FIG. 3, the recessed portion 50 surrounds the plurality of terminals 23 in plan view as viewed from the first direction X1. The recessed portion 50 collectively surrounds the plurality of terminals 23 in plan view as viewed from the first direction X1, for example. One recessed portion 50 accommodates ten terminals 23. The inner surface defining the recessed portion 50 is space apart from the terminals 23 in plan view as viewed from the first direction X1.

The recessed portion 50 is formed such that the leading end of the protruding portion 45 in the radial inner direction pushes into the recessed portion 50 in plan view as viewed from the first direction X1. In other words, the leading end of the protruding portion 45 in the radial inner direction is formed to push into the recessed portion 50 in plan view as viewed from the first direction X1. The recessed portion 50 extends, for example, radially outward from the leading end of the protruding portion 45 in plan view as viewed from the first direction X1. The recessed portion 50, for example, surrounds the leading end of the protruding portion 45 inwardly in the radial direction from three directions in plan view as viewed from the first direction X1. Specifically, the recessed portion 50 surrounds the leading end of the protruding portion 45 in the inner radial direction, from three directions, namely, the third direction Z1, the second direction Y1, and the second opposite direction Y2, in plan view as viewed from the first direction X1.

The recessed portion 50 is formed such that the leading ends of the protruding portions 46 in the radial inner direction push into the recessed portion 50 in plan view as viewed from the first direction X1. In other words, the leading ends of the protruding portions 46 in the radial inner direction push into the recessed portion 50 in plan view as viewed from the first direction X1. The recessed portion 50 extends, for example, radially outward from the leading ends of the protruding portions 46 in plan view as viewed from the first direction X1. The outer edge of the recessed portion 50 has, for example, a shape that conforms to the leading ends of the tapered protruding portions 46 in plan view as viewed from the first direction X1.

The recessed portion 50, for example, extends inside the inside of the enlarged recessed portion 48 in plan view as viewed from the first direction X1. The outer edge of a portion of the recessed portion 50 that extends into the enlarged recessed portion 48 has a corrugated shape, for example.

The outer edge of the recessed portion 50 has a curved shape that is curved away from the terminals 23 disposed radially outward of the first connector fitting portion 40 in a plan view as viewed from the first direction X1, out of the plurality of terminals 23. The outer edge of the recessed portion 50 in the present embodiment is formed only in a curved shape in plan view as viewed from the first direction X1. The outer edge of the recessed portion 50 of the present embodiment has eight arc-like shapes 51 that are curved in an arc-shaped manner away from each of the eight terminals 23 disposed radially outward of the first connector fitting portion 40, out of the ten terminals 23. The outer edge of the recessed portion 50 in the present embodiment is formed by the eight circular arc-like shapes 51 being continuous with each other. The leading end in the radial inner direction of the protruding portion 45 is surrounded from three directions by two arc-like shapes 51. The shape conforming to the leading end of each protruding portion 46 in the radial inner direction is formed by two arc-like shapes 51. Four arc-like shapes 51 extend into the inside of the enlarged recessed portion 48.

### Configuration of Potting Material 24

The potting material 24 is filled in the recessed portion 50. Therefore, the potting material 24 has the same shape as the recessed portion 50 in plan view as viewed from the first direction X1. The potting material 24 surrounds each of the plurality of terminals 23. The potting material 24 is bonded to each of the plurality of terminals 23. The potting material 24 is a sealing material that seals the plurality of terminals 23.

The potting material 24 surrounds the entirety of the outer circumferential surface of each of the terminals 23 in an intimate contact state, for example. As shown in FIG. 1, the potting material 24, for example, coats the terminals 23 in a state where the axially intermediate portions of the terminals 23 are embedded therein.

### Configuration of Second Connector Fitting Portion 60

The second connector fitting portion 60 protrudes from the end surface of the bottom wall 34 of the insertion portion 33 in the first opposite direction X2, that is, the second end surface 32 of the body portion 30 in the first opposite direction X2. The second connector fitting portion 60 protrudes toward the internal space of the device case 200. The second connector fitting portion 60, for example, is fitted with a second counterpart connector (not shown) provided inside the device case 200. The second connector fitting portion 60, for example, has a non-waterproof structure to which the second counterpart connector, which is a non-waterproof connector, is fitted.

The second connector fitting portion 60, for example, is open in the first opposite direction X2. The second connector fitting portion 60, for example, surrounds the outer circumference of the terminals 23 protruding from the end surface of the terminal holding portion 35 in the first opposite direction X2. The inner circumferential surface of the second connector fitting portion 60 is spaced apart from the terminals 23. The inner circumferential surface of the second connector fitting portion 60, for example, surrounds the entirety of the outer circumferences of the terminals 23 in the circumferential direction while spaced apart from the terminals 23.

The second connector fitting portion 60 has a through hole 61 provided in a portion of the second connector fitting portion 60 in the circumferential direction. The through hole 61 communicates the inside and outside of the second connector fitting portion 60 with each other. The through hole 61 extends through the circumferential wall of the second connector fitting portion 60 in the third direction Z1, for example. The through hole 61 is provided in an intermediate portion of the second connector fitting portion 60 in the axial direction. The inner surface defining the through hole 61 is engageable with, for example, an engagement projection (not shown) included in the second counterpart connector.

Next, the operations and effects of the present embodiment will be described.

(1) The relay connector 10 has the plurality of conductive terminals 23 and the housing 20. The housing 20 has the body portion 30 that holds the plurality of terminals 23 and the tubular first connector fitting portion 40 that protrudes from the first end surface 31 of the body portion 30 in the first direction X1. The housing 20 has the tubular second connector fitting portion 60 protruding from the second end surface 32 provided opposite to the first end surface 31 of the body portion 30 in the first opposite direction X2 that is the opposite direction to the first direction X1. The relay connector 10 has the recessed portion 50 that is recessed from the first end surface 31 of the body portion 30 in the first opposite direction X2 and surrounds the plurality of terminals 23, and the potting material 24 that is filled in the recessed portion 50 and seals the plurality of terminals 23. The housing 20 has the one or more protruding portions 45 and 46 protruding from the inner circumferential surface of the first connector fitting portion 40 radially inward of the first connector fitting portion 40 while protruding from the first end surface 31 in the first direction X1. The leading ends of the protruding portions 45 and 46 in the radial inner direction push into the recessed portion 50 in plan view as viewed from the first direction X1.

According to this configuration, the leading ends of the protruding portions 45 and 46 protruding radially inward from the inner circumferential surface of the first connector fitting portion 40 push into the recessed portion 50 in plan view viewed in the first direction X1. In other words, the recessed portion 50, which is filled with the potting material 24 extends radially outward from the leading ends of the protruding portions 45 and 46. Therefore, even if the leading ends of the protruding portions 45 and 46 extend to the vicinity of the terminals 23, for example, due to the reduction in size of the opening the first connector fitting portion 40, the outer edge of the recessed portion 50 can be suitably spaced apart from the terminals 23 to ensure a long distance between the outer edge of the recessed portion 50 and the terminals 23. This can suppress the reduction of the distance between the outer edge of the recessed portion 50 and the terminals 23 compared with a case where the recessed portion 50 is formed only in the region radially inward of the leading ends of the protruding portions 45 and 46. As a result, stress concentration in the potting material 24 that is filled in the recessed portion 50 can be suppressed, and cracking of the potting material 24 can be suitably suppressed.

(2) The recessed portion 50 surrounds the leading end of the protruding portion 45, which is the misassembly-prevention protruding portion, from the three directions in plan view as viewed from the first direction X1. According to this configuration, the recessed portion 50 can be curved to surround the sidewall at the leading end of the protruding portion 45. In this manner, the recessed portion 50 suitably extends radially outward from the leading end of the protruding portion 45. In this manner, the reduction in distance between the outer edge of the recessed portion 50 and the terminals 23 can be suitably suppressed, even when the leading end of the protruding portion 45 extends to the vicinity of the terminals 23. As a result, cracking of the potting material 24 can be suitably suppressed.

(3) The leading ends of the protruding portions 46 are tapered. The leading ends of the protruding portions 46 in the radial inner direction are thus spaced further apart from the terminals 23 progressively toward the side wall of the protruding portions 46. The recessed portion 50 has a shape conforming to the leading ends of the protruding portions 46. This allows the outer edge of the recessed portion 50 to be suitably spaced apart from the terminals 23. In this manner, reduction in distance between the outer edge of the recessed portion 50 and the terminals 23 can be suitably suppressed even when the leading ends of the protruding portions 46 extend to the vicinity of the terminals 23.

(4) The enlarged recessed portion 48 that enlarges the internal space of the first connector fitting portion 40 is provided on the inner surface of the first connector fitting portion 40. This allows the internal space of the first connector fitting portion 40 to be enlarged while suppressing an increase in size of the first connector fitting portion 40. Furthermore, since the recessed portion 50 extends into the enlarged recessed portion 48, the outer edge of the recessed portion 50 can be suitably spaced apart from the terminals 23 to ensure a long distance between the outer edge of the recessed portion 50 and the terminals 23.

(5) The outer edge of the recessed portion 50 has a curved shape. This improves the fluidity of the potting material 24 when filling the potting material 24 in the recessed portion 50. In this manner, retention of the potting material 24 at the outer edge of the recessed portion 50 can be suppressed, thus suitably preventing the potting material 24 from creeping up at the recessed portion 50 at the outer edge of the recessed portion 50.

(6) The outer edge shape of the recessed portion 50 consists only of a curved shape. This allows for better flowability of the potting material 24 when filling the recessed portion 50. This allows for better control of the potting material 24 creeping up at the outer edge of the recessed portion 50.

(7) The counterpart connector 100, which is a non-waterproof connector, is fitted inside the first connector fitting portion 40. In this case, the opening of the first connector fitting portion 40 is smaller, so the leading ends of the protrusions 45 and 46 tend to extend to the vicinity of the terminals 23. Even in this case, reduction in the distance between the outer edge of the recessed portion 50 and the terminals 23 can be suitably suppressed. As a result, cracking of the potting material 24 can be suitably suppressed.

### Other Embodiments

The present embodiment can be implemented with variations such as the following. The present embodiment and the following variations can be implemented in combination with each other as long as no technical contradiction arises.
The structure of the first connector fitting portion 40 in the above embodiment can be changed as needed.
In the above embodiment, the first connector fitting portion 40 has a non-waterproof structure, but there is no limitation to this. For example, the first connector fitting portion 40 may have a waterproof structure to which a counterpart connector, which is a waterproof connector, is to be fitted. In this case, for example, the through holes 49 are omitted.
The number and position of the protruding portions 45, 46, and 47 in the above embodiments can be changed as needed.
The protruding portions 47 of the above embodiment may be omitted.
Either the protruding portions 45 or 46 in the above embodiment may be omitted.
The enlarged recessed portion 48 of the above embodiment may be omitted.
The structure of the second connector fitting portion 60 of the above embodiment may be changed as needed.
In the above embodiment, the second connector fitting portion 60 has a non-waterproof structure, but there is no limitation to this. For example, the second connector fitting portion 60 may have a waterproof structure to which a second counterpart connector, which is a waterproof connector, is to be fitted. In this case, for example, the through hole 61 is omitted.
The structure of the recessed portion 50 in the above embodiment can be changed as needed.
In the above embodiment, the outer edge of the recessed portion 50 is formed only by a curved shape, but there is no limitation to this. For example, the outer edge of the recessed portion 50 may be changed to include a linear shape.
In the above embodiment, the recessed portion 50 is formed in the first end surface 31 facing the outside of the device case 200, but there is no limitation to this. For example, the recessed portion 50 may be formed in a surface facing the inside of the device case 200. For example, the recessed portion 50 may be formed in the end surface of the terminal holding portion 35 in the first opposite direction X2.
In the above embodiment, the seal member 25 is embodied as a rubber ring made of rubber, but there is no limitation to this. For example, a ring member made of an elastic material other than rubber may be used as the seal member 25.
The above embodiment is embodied as the relay connector 10 attached to the device case 200, which is a transmission case, but there is no limitation to this. For example, the present invention may be applied to a relay connector used for a device case other than the transmission case. The environment inside the device case 200 where the relay connector 10 is installed is not limited to an oil environment, but can be applied to a relay connector for device where oil is not used inside the device case 200.
The recessed portion 50 of the illustrated non-limiting embodiment is an example of a potting resin receiving pit configured to accommodate potting resin, which can be the potting material 54. In plan view of the recessed portion 50 (FIG. 3), the recessed portion 50 can have an inner-pit circumferential wall surface that is in direct contact with the potting resin. The inner-pit inner circumferential wall of the recessed portion 50 may be configured such that the potting resin has a potting resin side surface formed from a plurality of potting material convex curved surfaces and a plurality of potting material concave surfaces provided alternately. For example, the inner-pit circumferential wall of the recessed portion 50 may be non-planar, and formed from a plurality of concave regions corresponding respectively to the plurality of potting material convex curved surfaces and a plurality of convex curved regions corresponding respectively to the plurality of potting material concave surface provided alternately. In plan view of the recessed portion 50 (FIG. 3), the leading end of the protruding portion 45 or the leading end of the protruding portions 46 may be oriented toward and be adjacent to the recessed bottom or deepest position of the corresponding one of the plurality of such concave regions of the inner-pit circumferential wall of the recessed portion 50.
The embodiment disclosed here is to be considered in all respects as illustrative and not limiting. The scope of the present invention is indicated by the scope of the claims rather than the meaning described above, and is intended to include all changes within the meaning and scope equivalent to the scope of the claims.

### LIST OF REFERENCE NUMERALS

10 Relay connector
20 Housing
23 Terminal
24 Potting material
25 Seal member
30 Body portion
31 First end surface
32 Second end surface
33 Insertion portion
33X Accommodation groove
34 Bottom wall
35 Terminal holding portion
36 Flange portion
37 Fixed portion
37X Through hole
38 Collar
39 Bottom wall
40 First connector fitting portion
41, 42, 43, 44 Circumferential wall
45 Protruding portion (misassembly-prevention protruding portion)
46 Protruding portion
47 Protruding portion
48 Enlarged recessed portion
49 Through hole
50 Recessed portion
51 Arc-like shape
60 Second connector fitting portion
61 Through hole
100 Counterpart connector
101 Counterpart housing
102 Misassembly-prevention groove
103 Guide groove
104 Guide groove
105 Engagement projection
200 Device case
201 Attachment hole
X1 First direction
X2 First opposite direction
Y1 Second direction
Y2 Second opposite direction
Z1 Third direction
Z2 Third opposite direction

1. A relay connector comprising:
a plurality of conductive terminals;
a housing including
a body portion holding the plurality of terminals
a tubular first connector fitting portion protruding in a first direction from a first end surface of the body portion; and
a tubular second connector fitting portion protruding in a first opposite direction opposite to the first direction from a second end surface provided opposite to the first end surface of the body portion;
a recessed portion recessed from the first end surface of the body portion in the first opposite direction and surrounding the plurality of terminals; and
a potting material filling the recessed portion and sealing the plurality of terminals,
wherein the housing includes one or more protruding portions protruding from the first end surface in the first direction, and protruding radially inward of the first connector fitting portion from an inner circumferential surface of the first connector fitting portion,
leading ends of the one or more protruding portions in a radial inner direction push into the recessed portion in plan view as viewed from the first direction,
the plurality of terminals are formed by a plurality of radially-outward terminals and one or more non radially-outward terminals other than the plurality of radially-outward terminals, and
an outer edge of the recessed portion is formed only by a curved shape in which a plurality of ark-like shapes are continuous in plan view as viewed from the first direction, and the plurality of ark-like shapes are provided in one-to-one correspondence with the plurality of radially-outward terminals.

2. The relay connector according to claim 1,
wherein the one or more protruding portions include a misassembly-prevention protruding portion, and
the recessed portion surrounds the leading end of the misassembly-prevention protruding portion in the radial inner direction from three directions in plan view as viewed from the first direction.

3. The relay connector according to claim 1,
wherein the leading ends of the one or more protruding portions in the radial inner direction are tapered, and
the outer edge of the recessed portion has a shape conforming to the leading ends of the one or more protruding portions in the radial inner direction in plan view as viewed from the first direction.

4. The relay connector according to claim 1,
wherein the housing has an enlarged recessed portion recessed from an inner circumferential surface of the first connector fitting portion outward in a radial direction of the first connector fitting portion and enlarging an internal space of the first connector fitting portion, and
the recessed portion extends into the enlarged recessed portion in plan view as viewed from the first direction.

5. The relay connector according to claim 1,
wherein the outer edge of the recessed portion has, in plan view as viewed from the first direction, a curved shape curved away from the plurality of radially-outward terminals disposed outward in the radial direction of the first connector fitting portion, out of the plurality of terminals.

6. The relay connector according to claim 1,
wherein the relay connector is configured to be attached to an attachment hole of a device case whose external space is an air environment and whose internal space is an oil environment,
the first end surface is an end surface facing the outside of the device case,
the second end surface is an end surface facing the inside of the device case,
the first connector fitting portion is provided to protrude into the external space of the device case, and
the second connector fitting portion is provided to protrude into the internal space of the device case.

717. The relay connector according to claim 1,
wherein the first connector fitting portion has a non-waterproof structure in which a counterpart connector, which is a non-waterproof connector, is configured to be fitted inside, and
the first connector fitting portion is provided in a portion of the first connector fitting portion in a circumferential direction and has a through hole that communicates the inside and outside of the first connector fitting portion.

8. The relay connector according to claim 1,
wherein, in plan view of the recessed portion,
the recessed portion includes an inner circumferential wall surface that is in direct contact with the potting material, and the inner circumferential wall of the recessed portion is configured such that the potting material has a potting resin side surface formed from a plurality of potting material convex surfaces and a plurality of potting material concave surfaces provided alternately, and
the inner circumferential wall surface of the recessed portion is a wave-shaped curved regions formed from a plurality of concave regions corresponding respectively to the plurality of potting material convex surfaces and a plurality of convex regions corresponding respectively to the plurality of potting material concave surface provided alternately.
